(19) United States
(12) Patent Application Publication
(10) Pub. No.: US 2015/0006262 A1
(43) Pub. Date: Jan. 1, 2015

(54) SYSTEM AND METHOD FOR MANAGING THE ACTIVITY OF A USER CORRESPONDING TO AN ORGANIZATIONAL INITIATIVE

(71) Applicant: Tamal BHATIA, Bangalore (IN)

(72) Inventor: Tamal BHATIA, Bangalore (IN)

(21) Appl. No.: 14/314,040

(22) Filed: Jun. 25, 2014

(30) Foreign Application Priority Data
Jun. 26, 2013 (IN) 2786/CHE/2013

(51) Int. Cl. G06Q 10/06

(52) U.S. Cl. CPC G06Q 10/06395
USPC 705/7.41

(57) ABSTRACT

A system and method for managing activities of users corresponding to an organizational initiative by allowing the user to commit at least one action element corresponding to the activity for a specific period of time. The system presents a commitment and the action element associated with the user to a plurality of observers. The system further receives an evaluation on the commitment associated with the user for the action element by the observers at the end of the specific period of time and collates the evaluations received from the observers to provide an assessment for the user. The system is further capable of sharing a collated evaluation of the user to a number of platforms. This system helps in creating a commitment from the user irrespective of the nature of the activity or the level in an organization that the user goes through.

CROSS REFERENCE TO RELATED APPLICATION

This application the benefit under 35 U.S.C. §119 (b) of an application entitled “SYSTEM AND METHOD FOR MANAGING THE ACTIVITY OF A USER CORRESPONDING TO AN ORGANIZATIONAL INITIATIVE” filed with Indian Patent Office Chennai on 26 Jun. 2013 and assigned an application No. 2786/CHE/2013, the entirety of which is expressly incorporated herein by reference.

### TECHNICAL FIELD OF THE INVENTION

The present invention relates to activity management of a user. In particular, the invention relates to a system and method for managing the activity of a user corresponding to an organizational initiative with the help of observers.

### BACKGROUND OF THE INVENTION

Managing the activities of employees is an important task for the overall growth of an organization. Management of activities includes tracking the change and transformation of human capital in the organization. Any initiation that is developmental in nature seeks change and transformation among the recipients of such initiation. Thus, in organizational context, any training or learning program or initiative seeks to create a desired change in an individual. Presently, this process has very low measurability and typical plotting of improvement is a function of a subjective opinion of superiors, peers or subordinates or a simple commitment from an individual that the skills they have learnt can be put to use in the workplace.

Organizations desire to track information about their employees regarding how the individuals in the organization receive various organizational initiatives and responded to that. This will helps in bringing out the effectiveness of organizational initiative in reality. There are many existing systems which take feedback from the recipients regarding the initiative. But such systems fail to capture how effectively the recipients implement the initiative in their day to day work. Effective implementation of the initiative by the individuals is always necessary in order to get outcome from the organizational initiative. Existing systems which will seek out how the individual who go through a proposal will try to apply ideas or learning or concepts from what has been imparted, organization will not have any form of commitment from the individual in the action that he/she choose to display his/her learning. Such systems provide ratings only from individual assessment but not assessment from others and also fail to create a sense of commitment in the individuals. Commitment from individuals provides a better sense of responsibility towards their learning activity. This will helps in giving more success to any organizational initiative. Presently there is no mechanism that enables the individual to commit to a change action which may be measured.

Thus, there is need for a system that helps in managing the activity of an individual by tracking the change and transformation of the individual to an organizational initiative.

### SUMMARY OF THE INVENTION

According to an embodiment, the invention discloses a system and method for managing an activity of a user corresponding to an organizational initiative. The system has a commitment module configured to allow the user to commit at least one action element corresponding to the activity for a specific period of time. The system also has a dissemination module configured to present a commitment and the action element associated with the user to a plurality of observers. The system further has an assessment module configured to receive an evaluation on the commitment associated with the user for the action element by the observers at the end of a specific period of time. The assessment module is further configured to collate the evaluations received from the observers to provide an assessment for the user.

The commitment module is further configured to generate a set of action elements based on user's response to a set of questions based on the activity. The action element is at least one selected from the set of action element generated and a user defined action element. The observers perform the evaluation anonymously.

The system further has an assessment sharing module configured to share a collated evaluation of the user to a number of platforms.

According to an embodiment, the invention also discloses a method for managing an activity of a user corresponding to an organizational initiative. The method includes the steps of committing for at least one action element corresponding to the activity for a specific period of time. The method further includes step of presenting a commitment and the action element associated with the user to a plurality of observers. The method also includes a step of receiving an evaluation on the commitment associated with the individual for the action element by the observers at the end of the specific period of time. Once the evaluation is done by all the observers the method does the step of collating the evaluations received from the observers to provide an assessment for the user.

According to an embodiment of the invention, the method also includes the step of sharing the collated evaluation result to a number of platforms.

The system provides a way to commit for an action element corresponding to the activity which gives a collaborative relationship between the user and the observer. This system also helps in creating a commitment from the user irrespective of the nature of the initiative or the level in the organization that he/she goes through. The system provides organizations an insight into the learning barriers and challenges that they face during change and transformation.

### BRIEF DESCRIPTION OF DRAWINGS

FIG. 1 illustrates an exemplary environment in which systems and methods consistent with the principles of the invention may be implemented.

FIG. 2 illustrates the block diagram for the system to manage activity of a user in accordance with an embodiment of the present invention.

FIG. 3 illustrates flow chart of the method for managing learning activity of a user in accordance with an embodiment of the present invention.

FIGS. 4-9 illustrate the various user interface present in the system in accordance with an embodiment of the present invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

Before describing in detail embodiments that are in accordance with the present invention, it should be observed that the embodiments reside primarily in combinations of system components related to a system and method for managing an activity of a user corresponding to an organizational initiative. The invention gives a way to evaluate how effectively an individual user implements an activity related to an organizational initiative. The invention also helps in giving overall effectiveness of the organizational initiative.

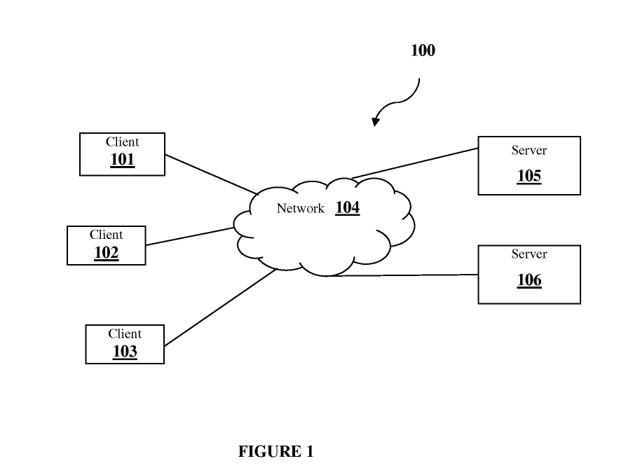

FIG. 1 illustrates an exemplary environment in which systems and methods consistent with the principles of the invention may be implemented. The network consists of several clients (101, 102, 103) where the system and method for managing activity of a user is implemented. These clients (101, 102, 103) interact with server (105) and transmit the various data required for the system and method for managing activity of the user to various clients through a network (104). The server (105) uses various databases for receiving and correlating the activity and the commitment received for each organizational initiative. In some embodiments, the server (105) may also connect to another server (106).

In practice, there will be more number of servers and clients. In some situations, a server may perform the functions of all the two servers (105, 106) illustrated in the FIG. 1. It may be also contemplated that server may be one or many. It is also possible that in case of a standalone application mode, a server may not exist and all the logic may be implemented in the client.

A client (101) may include any device such a personal computer, laptop, mobile device, tablet, set top box (STB), television(TV), gaming devices, or any other types of device that can support two way interactions with the user either using a graphical user interface or through other interface mechanisms such as voice or gesture or video. Thus, client (101) may be any device that is capable of displaying or receiving the information related to the system,

In some cases all or part of the server configurations may be running on the client (101). In some cases, the client (101) may connect to multiple servers during the process of managing activity. In certain scenario, the client (101) may perform the functions of server or server may perform client functions.

The above mentioned functions may be part of one server or several servers and each server may implement the functionalities of others. It may be possible that any of the server may be implemented using a cluster of servers involving two or more separate devices with all the other associated devices like load balancer, firewall, routers etc.

Network (104) may include for example a local area network (LAN), a wide area network (WAN), a Wide Local Area Network (WLAN), Wireless Personal Area Network (WPAN), Wireless Metropolitan Area Network (WMAN), a telephone network, such as the Public Switched Telephone Network (PSTN), an intranet, the Internet, a memory device, or a combination of networks. The network (104) may be wired, wireless, optical, or any other information transmission mechanisms.

The system helps to create commitment in a user wherein the commitment is an action from the user, irrespective of the level in organization that he/she go through. The system mainly involves the commitment and multi rater feedback.

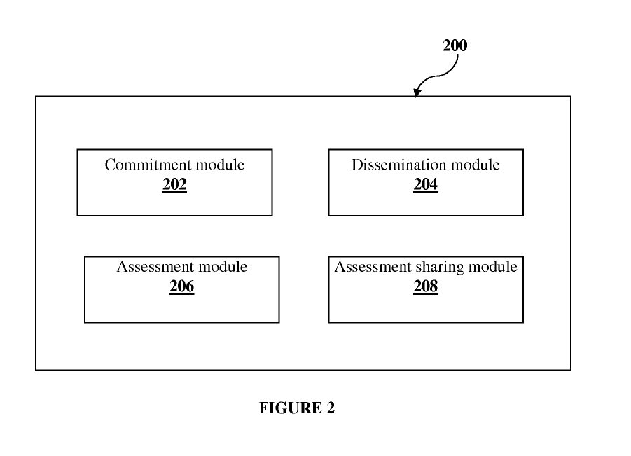

FIG. 2 illustrates block diagram for the system to manage activity of a user. The system (200) includes various modules such as a commitment module (202), a dissemination module (204), an assessment module (206) and an assessment sharing module (208) configured for managing the activity of the user.

According to an embodiment of the invention, the commitment module (202) is configured to allow the user to commit at least one action element corresponding to an activity for a specific period of time. Once the user commits for the action element, these commitments are presented to a plurality of observers by the dissemination module (204). The assessment module (206) receives an evaluation on the commitment associated with the user for the action element by the observers at the end of the specific period of time. The assessment module (206) further does the collation of the evaluations received from the observers to provide an assessment for the user. This gives an overall assessment of the user for a particular activity based on the evaluation of the action element. The assessment sharing module (208) is configured to share a collated evaluation of the user to a plurality of platforms

It is envisaged that the activity corresponding to the organizational initiative includes but not limited to learning activity, business process, project management, customer service, research and development and so on where a commitment is made by the user for the activity.

According to an embodiment of the invention learning activity based on organizational initiatives includes parental initiative or self initiative. The organizational initiative also includes any sort of training, learning and development programs or any other organizational initiative through which the organization seeks to change and align its people to a desired goal.

According to an embodiment of the invention the commitment module (202) is also responsible for generating a set of action elements. The action elements are generated based on the user's response to a set of questions related to the activity. The system is fed with all the necessary questions for the activity. The action elements may be any act the user may perform in order to succeed in the activity. The commitment module (202) also enables users to add an action element of their own based on the activity apart from the system generated action elements. In an embodiment, the user is allowed to commit for more than one action element for the activity in any combination, that is, the committed action elements may be only from the list of system generated action elements or combination of both user added and system generated action elements or only user added action elements. This commitment is the action that the users perform in order to demonstrate their commitment and ability to change. Once the user successfully commits to the action element, the dissemination module (204) presents the action elements committed by the user to a number of observers. The observers may be user's peers, colleagues, buddies, manager, clients or customers when the system is being implemented for an organization. In some scenarios, the observer may be user's classmates, teachers or siblings where the system is being implemented for the students of schools or colleges. Depending upon the place where the system is being used, the observers may differ. The system is also capable of determining the observers for each user based on the activity they have under gone. In some scenarios, the system may give a provision to the users in order to select the observers based on user's choice. This system is also capable of being used for all the employees in the organization. In such scenario, the user may be observer and vice-versa.

In some scenarios the observers are notified about the commitment by the dissemination module by means of email alerts or as message or alerts in social network platforms or as an SMS.

According to an embodiment of the invention, when the specified period of time for which commitment is made by the user is over, the system may transmit out alerts to a number of observers informing them to perform evaluation on the commitment made by the users. The evaluation done by the observers is received by the assessment module (206). The evaluation is performed either by means of feedback or by providing ratings on the commitment made by the user. The evaluation may be performed in the form of polls. If the observer fails to perform the evaluation, the system sends alerts reminding them to do the evaluation. Once the assessment module (206) receives the evaluations performed by all the observers, the evaluation module does collation of all the evaluations. Thus, the user receives a collated evaluation for his commitment. The observer does the evaluation anonymously. The user is capable of viewing the evaluation but not the observer. This module is further capable of providing a learning curve or developmental curve with respect to the organizational initiative for the users when the system is being implemented for all the employees in an organization. This helps the organization to evaluate how effectively their organizational initiatives are executed by the employees.

According to another embodiment of the invention, the assessment sharing module (208) is configured to share the collated assessment provided by the assessment module (206) to a number of platforms. The platforms includes social media networks such as Face book, LinkedIn or any other such networks intended to build social networks or relationships among people who, for example share interests, activities, background or real-life connections. In some scenario the platform may be users profile website which showcases the user's achievements and experiences. This collated assessment provides an indicator of the user's capability to change and transform based on the learning.

According to an embodiment of the invention, when the observer is presented with the commitment made by the user, the observer is provided with an option to suggest some action element based on the activity of the user. This provides a more collaborative interaction between the user and the observer which will enhance the implementation of the activity.

According to an embodiment of the invention, the evaluations are performed by the observers anonymously. In this embodiment, the user won't know which observer evaluates how much. This helps in receiving a fair evaluation for the user. The user views the evaluation of each observer against some dummy names so as to keep the observer anonymous. Thus, the system shows only the evaluation of the observer to the user not the observer's identity.

According to another embodiment of the invention, when the system is implemented for a number of users in an organization, the system provides a user interface where various correlation and graphs of the users related to various activities may be viewed. The system provides the graphs for each user for each of the learning activities, developmental activities as well as for all the activities, the user has undertaken. Similarly using the system the organization may manage the various activities of all the employees.

An exemplary scenario in which this system works is as follows. The system is implemented in an organization. The organization conducts a training program for the employees for personality development. After the completion of the training program the organization decides to track the employees for how effectively they learned from the training program by implementing the system for managing learning activity. The system may be fed with a number of questions related to the learning activity. The user has to respond to these questions in order to generate a set of action elements related to the learning activity. The system also provides an option to the users to add their own action elements for the learning activity. The user is required to commit for at least one action element which makes the commitment process more effective as the user is taking the responsibility himself. The commitment is done for a specific period of time. Once the user performs the commitment to the action elements, the commitment along with the action element for the learning activity is presented to a number of observers. Observers may be his peers, managers or any other person who is interested in knowing the learning activities of the user in the organization. Once the specific period of time is over, the system starts the evaluations of the users. The observer of the user has to give their evaluation. The system will send some alerts if the observer fails to perform the evaluation of the user. Once the system receives the evaluation of all the users then the entire evaluation is collated to give a single evaluation for the user. Likewise the system may be implemented for many learning activities of the user and also for many users in an organization. Thus, the organization may get to know the overall learning activities of all the users for various learning activity by implementing this system.

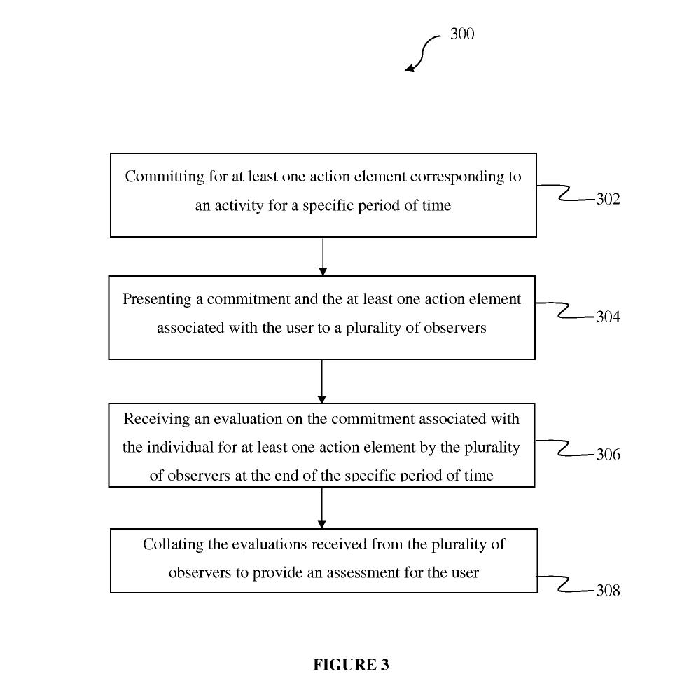

FIG. 3 illustrates the flow chart of method for managing an activity of a user corresponding to an organizational initiative in accordance with an embodiment of the present invention. The method initiates at step (302) by committing for at least one action element corresponding to the activity for a specific period of time. At step (304), a commitment along with the action element associated with the user is presented to a plurality of observers. Once the specific period of time is over the observers will start evaluating the user on the commitment and the action element based on the commitment is done at step (306). Once the evaluation is performed by all the observers, at step (308) the entire evaluation by all the observers for the user is collated. The collated result gives the overall evaluation of the user activity for the action element the user has committed. This action element is selected from a set of action elements defined by the user, based on the user's response to a set of questions based on the activity. The user is also provided with a choice to add own action elements corresponding to the activity.

According to an embodiment of the invention, the method for managing an activity of a user corresponding to an organizational initiative of a user also includes a step of sharing the collated evaluation of the user to a number platform. The number of platforms includes social media networks such as Face book, LinkedIn or any other such networks.

The method as described above includes a series of steps and their order of execution in the embodiments of the invention illustrated and described herein is not essential, unless otherwise specified. That is, the steps may be performed in any order, unless otherwise specified, and embodiments of the invention may include additional or fewer steps than those disclosed herein. It may be envisioned that executing or performing a particular step before, contemporaneously with, or after another step is within the scope of the invention.

According to an embodiment of the invention, the entire system resides in the cloud. The system may exist as a standalone system or it can be associated with any of the existing systems in an organization.

The system and method disclosed may be incorporated with any sort of activity related to an organizational initiative for any individual. It may be noted that the system is also capable of being implemented in a school, college or any other organization, not limited to industrial or service or government organizations. In some scenario the system may be implemented on the children by their parents in order to give them a sense of commitment and to track the change and transition in the child for any activity related to the initiative. The activity may be even a simple act such as getting up early in the morning or keep the house neat and clean or the like.

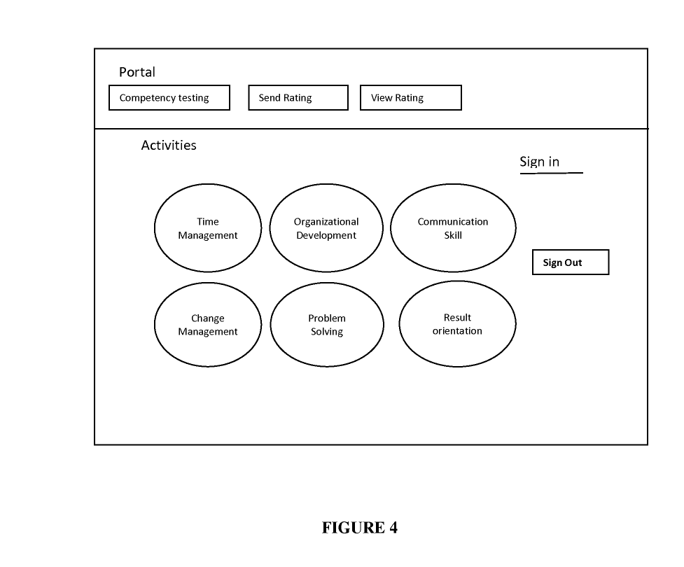

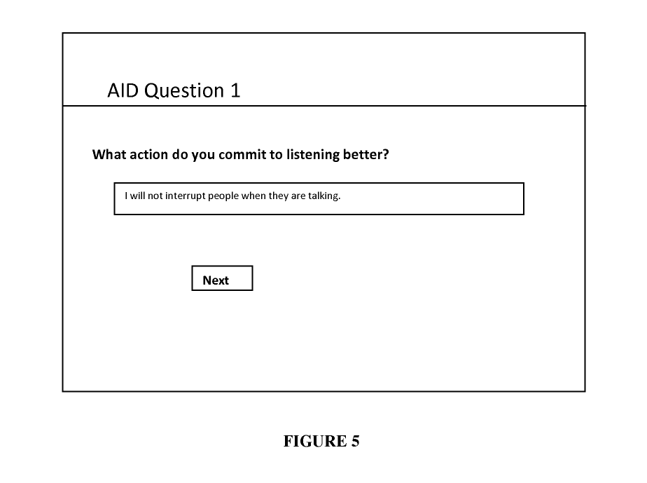

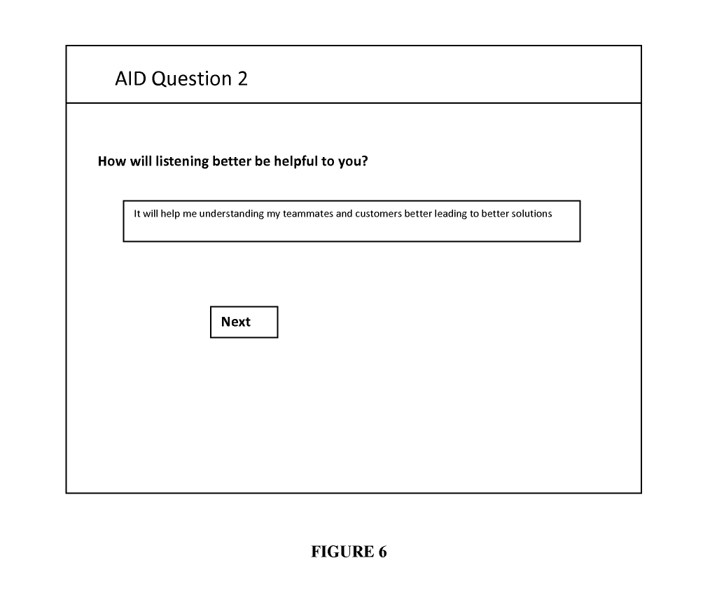

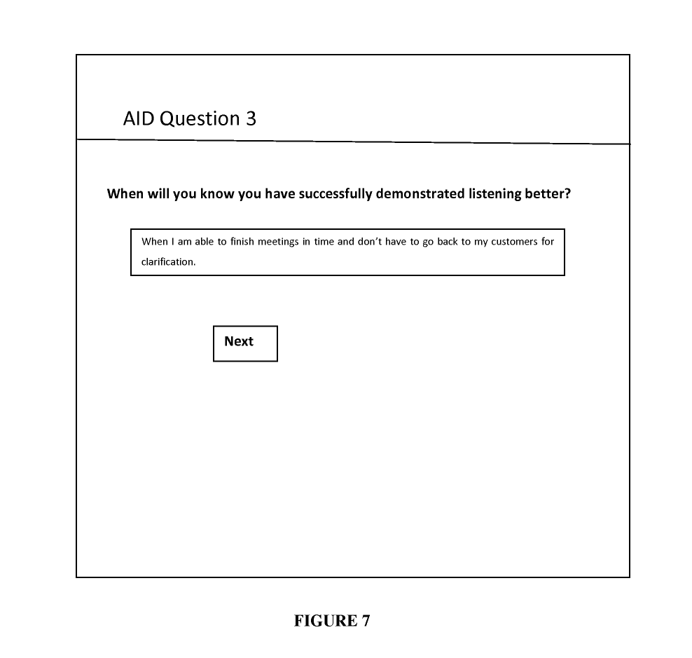

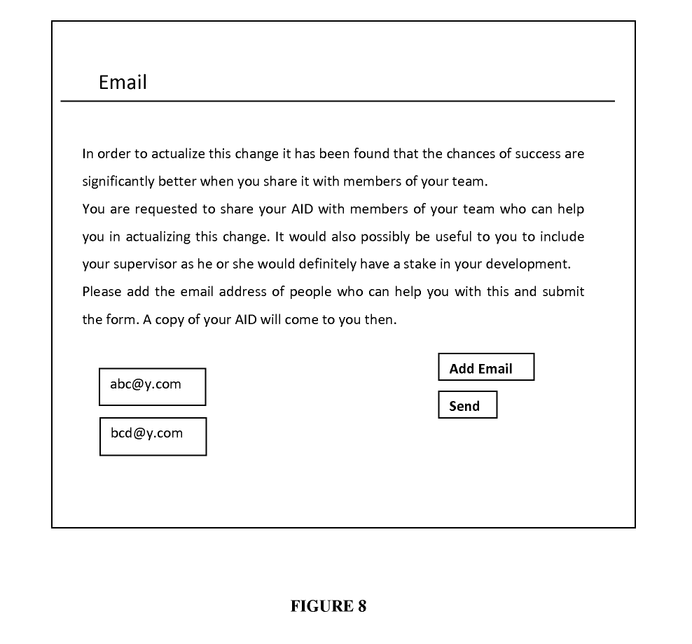

FIGS. 4-9 illustrate various user interfaces present in the system in accordance with an embodiment of the present invention. FIG. 4 illustrates the user interface for the user showing the various activities corresponding to learning activity initiated by an organization. Once the user selects a particular learning activity, the system may show the user with a number of questions related to his learning activity. Example questions are shown in FIGS. 5-7. Once the user completes answering the questions, the system gives an option to the user to add email address of the observers whom the user likes to add. Once the user enters the email details of the desired observers then the system send the email. The user interface for entering the observers email ID is illustrated in FIG. 8. Once the emails are entered and the user clicks on a send button the system sends an email to all the observers. An exemplary email sent by the system is as follows:

Dear Colleague,

I am requesting your support in evaluating certain competencies that I have identified for improvement. This email is intended to document Action Intent Dissemination (AID) aspect which requires me to commit to a define time bound actions over the next few weeks.

Competency: Listening

Here are the questions and answers that document my commitment and parameters for your evaluation.

What action do you commit to Listening better?

I will not interrupt people when they are talking.

How will listening better be helpful to you?

It will help me understanding my teammates and customers better leading to better solutions.

When will you know you have successfully demonstrated listening better?

When I am able to finish meetings in time and don't have to go back to my customers for clarification.

I will reach out to you for your evaluation over the next few days once the committed actions are complete. I look forward to your support in providing me an objective evaluation and enable me to improve my competencies.

Thanks in Advance!

Individual Seeking Rating

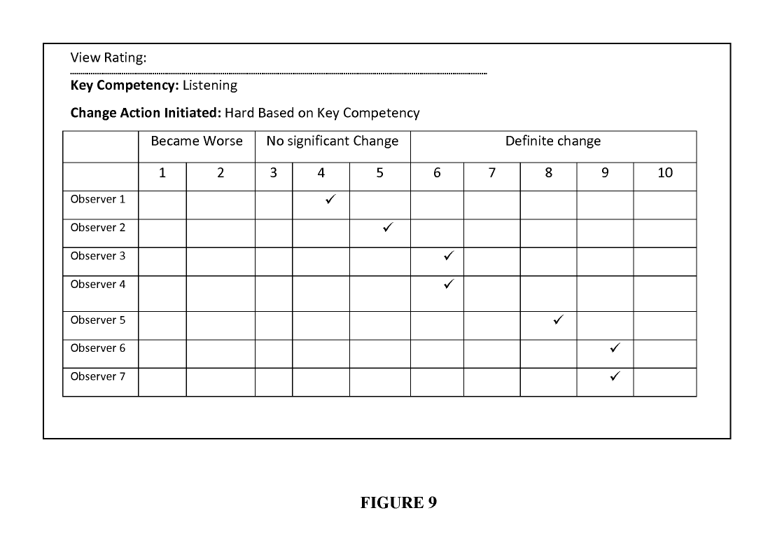

Once a specific period of time for which the user has committed for the learning activity is over, the observers are provided with a user interface through which they can enter their rating. Once all the observers rate the user, the user receives a consolidated rating sheet containing the rating of each observer as illustrated in FIG. 9. Here the rating of each observer is shown by naming each observer as observer 1, observer 2 and so on. This ensures the anonymity in providing the feedback to the user. None of the users who use the system is able to view who is the observer who has rated a user. He may only understand that the rating is given by one of the observer.

According to an embodiment of the invention the system may be used for achieving a business goal. In such scenario the activity is to increase the market share and revenue. The action elements to which the user commits may be to make at least six new client calls per week, making at least four customers visit and so on. These action elements are later shared with the user's manager, peers, subordinates or any other person who is capable of rating the user. Similarly the system may be used for project management, where the project has certain deadlines, goals and deliverable to which the user commits and being evaluated. The system is also envisaged to be used in customer services, research and development, hospitals and so on.

The present system helps in creating a commitment from the individual irrespective of the nature of the initiative or the level in the organization that she or he goes through. The rating of change is a multi-rater feedback that quantifies the ability of the individual to demonstrate the commitment. The dissemination of the action element initiated creates a collaborative process in change and transformation that is missing today. The organization has the ability to customize the system for various activities such as learning activity, developmental activity and so on. The system also helps in retrieving the organizational level learning activity or developmental activity of multiple users. The system is deployable for any kind of initiative be it instructor led or virtual. The system creates leader boards for organizations on change and transformation. It provides organizations an insight into learning barriers and challenges that the organization faces in change and transformation. The system helps in achieving change and transformation through engagement. This system seeks to create a measurement for any sort of activity initiated by the organization including learning activity, developmental activity which in turn measures the change and transformation in the region of human capital. This is achieved by first getting individuals to commit to a specific action related to the initiative, which demonstrates his/her desire to change and this commitment is communicated to various individuals who works with the individual and who is able to rate the ability of the individual to demonstrate the change. At an organizational level it allows the organization to look, how the human capital of the organization is able to achieve this change and transformation with a variety of different data points.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the embodiments as described herein.

I claim:

1. A system for managing an activity of a user corresponding to an organizational initiative, the system comprises:
a. a commitment module configured to allow the user to commit at least one action element corresponding to the activity for a specific period of time;
b. a dissemination module configured to present a commitment and the action element associated with the user to a plurality of observers;
c. an assessment module configured to:
receive an evaluation on the commitment associated with the user for the action element by the observers at the end of the specific period of time;
collate the evaluations received from the observers to provide an assessment for the user.

2. The system as claimed in claim 1, wherein the commitment module is further configured to generate a set of action elements based on the user's response to a set of questions based on the activity.

3. The system as claimed in claim 2, wherein the action element is at least one of:
a. a set of action element generated; or
b. a user defined action element.

4. The system as claimed in claim 1, wherein the observer performs the evaluation anonymously.

5. The system as claimed in claim 1, wherein the assessment module is further configured to send at least one alert to the observers to initiate evaluation of the user.

6. The system as claimed in claim 1, wherein the evaluation is received in the form of at least one of;
a. rating;
b. feedback; or
c. poll,
from the observers.

7. The system as claimed in claim 1 further comprising an assessment sharing module configured to share a collated evaluation of the user to a plurality of platforms.

8. A method for managing an activity of a user corresponding to an organizational initiative, the method comprising the steps of:
a. committing for at least one action element corresponding to the activity for a specific period of time;
b. presenting a commitment and the action element associated with the user to a plurality of observers;
c. receiving an evaluation on the commitment associated with the individual for the action element by the observers at the end of the specific period of time;
d. collating the evaluations received from the observers to provide an assessment for the user.

9. The method as claimed in claim 8, further comprising the step of generating a set of action elements based on the user's response to a set of questions based on the activity.

10. The method as claimed in claim 8, wherein the observer performs the evaluation anonymously.

11. The method as claimed in claim 8, wherein an action element is at least one of:
a. a predefined action element; and
b. a user defined action element.

12. The method as claimed in claim 8, further comprising the steps of sharing a collated evaluation of the user to a plurality of platforms.
